(19) United States
(12) Patent Application Publication
(10) Pub. No.: US 2019/0289665 A1
(43) Pub. Date: Sep. 19, 2019

(54) Fast And Reliable Signaling Designs For Mobile Communications

(71) Applicant: MediaTek Inc., Hsinchu City (TW)

(72) Inventors: Weidong Yang, San Diego, CA (US); Chia-Chun Hsu, Hsinchu City (TW); Yih-Shen Chen, Hsinchu City (TW); Pavan Santhana Krishna Nuggehalli, San Jose, CA (US); Lung-Sheng Tsai, Hsinchu City (TW); Yuanyuan Zhang, Beijing (CN)

(21) Appl. No.: 16/353,491

(22) Filed: Mar. 14, 2019

Related U.S. Application Data
(60) Provisional application No. 62/644,477, filed on Mar. 17, 2018.

(51) Int. Cl. H04W 80/02; H04W 72/04

(52) U.S. Cl. CPC H04W 80/02; H04W 72/0453; H04W 72/0446; H04W 72/042

(57) ABSTRACT

A first network node receives downlink signaling from a second network node in a first occasion, received on a first carrier in a first time slot, and a second occasion, which is received either on the first carrier in a second time slot after the first time slot or on a second carrier in the first time slot or the second time slot. A MAC control element (CE) in the downlink signaling received in the first and second occasions contain a first timing padding value and a second timing padding value, respectively. A predetermined time slot is equally indicated by the first time slot plus the first timing padding value as well as by the second time slot plus the second timing padding value. The first network node effects one or more configurations in the predetermined time slot responsive to receiving the downlink signaling in the first and second occasions.

### CROSS REFERENCE TO RELATED PATENT APPLICATION(S)

The present disclosure is part of a non-provisional application claiming the priority benefit of U.S. Patent Application Nos. 62/644,477, filed 17 Mar. 2018, the content of which is incorporated by reference in its entirety.

### TECHNICAL FIELD

The present disclosure is generally related to mobile communications and, more particularly, fast and reliable signaling design for mobile communications.

### BACKGROUND

Unless otherwise indicated herein, approaches described in this section are not prior art to the claims listed below and are not admitted as prior art by inclusion in this section.

In 5th-Generation (5G) New Radio (NR) mobile communications, certain signaling such as radio resource control (RRC), medium access control (MAC) control element (CE)-based activation and deactivation signaling, and physical downlink control channel (PDCCH)-based signaling, have been considered and used to configure or select measurement resources and reporting in the context of channel state information (CSI) acquisition. While RRC signaling is highly reliable in conveying the configuration/selection from a network (e.g., via a network node such as gNB) to a user equipment (UE), signaling latency is nevertheless substantial. With dynamic signaling through PDCCH, although signaling latency can be small, typically PDCCH operates at an error rate of 1% which does not provide a reliable link for the network to signal important information to the UE.

With MAC CE-based activation/deactivation, signaling latency can be smaller than that with RRC signaling, yet the reliability of MAC CE-based signaling is still lacking. That is, a number of factors need to be satisfied in order for a MAC CE to be successfully received by a UE and for the corresponding acknowledgement (ACK) to be successfully received by the network. Firstly, the UE needs to receive the PDCCH which schedules a physical downlink shared channel (PDSCH) that contains the MAC CE (and PDCCH typically has an error rate of 1%). Secondly, the UE needs to decode the PDSCH successfully (and PDSCH typically has a target error rate of 10%). Thirdly, the UE needs to transmit an ACK in uplink and the network needs to successfully receive the ACK.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose schemes, solutions, concepts, designs, methods and apparatuses pertaining to a fast and reliable signaling design for mobile communications. Specifically, under various schemes proposed in accordance with the present disclosure, reliable and low-latency signaling designs without an ambiguity period is introduced.

In one aspect, a method may involve a processor of a first network node of a wireless network receiving downlink (DL) signaling from a second network node of the wireless network in a first occasion and a second occasion, such that: (a) the first occasion is received on a first carrier in a first time slot, (b) the second occasion is received either on the first carrier in a second time slot after the first time slot or on a second carrier in the first time slot or the second time slot, (c) a MAC CE in the DL signaling received in the first occasion comprises a first timing padding value, (d) the MAC CE in the DL signaling received in the second occasion comprises a second timing padding value, (e) the second timing padding value is different from the first timing padding value in an event that the second occasion is received on the first carrier in the second time slot, and (f) a predetermined time slot is equally indicated by the first time slot plus the first timing padding value as well as by the second time slot plus the second timing padding value. The method may also involve the processor effecting one or more configurations in the predetermined time slots responsive to receiving the DL signaling in the first occasion and the second occasion.

In one aspect, a method may involve a processor of a first network node of a wireless network transmitting uplink (UL) signaling to a second network node of the wireless network in a first occasion and a second occasion, such that: (a) the first occasion is transmitted on a first carrier in a first time slot, (b) the second occasion is transmitted either on the first carrier in a second time slot after the first time slot or on a second carrier in the first time slot or the second time slot, (c) a second MAC CE in the UL signaling transmitted in the first occasion comprises a first timing padding value, (d) the second MAC CE in the UL signaling transmitted in the second occasion comprises a second timing padding value, (e) the second timing padding value is different from the first timing padding value in an event that the second occasion is transmitted on the first carrier in the second time slot, and (f) a second predetermined time slot is equally indicated by the first time slot plus the first timing padding value as well as by the second time slot plus the second timing padding value.

In one aspect, an apparatus implementable in a first network node of a wireless network may include a transceiver and a processor coupled to the transceiver. The transceiver may be capable of wirelessly communicating with a second network node of the wireless network. The processor may be capable of receiving, via the transceiver, DL signaling from the second network node in a first occasion and a second occasion, such that: (a) the first occasion is received on a first carrier in a first time slot, (b) the second occasion is received either on the first carrier in a second time slot after the first time slot or on a second carrier in the first time slot or the second time slot, (c) a MAC CE in the DL signaling received in the first occasion comprises a first timing padding value, (d) the MAC CE in the DL signaling received in the second occasion comprises a second timing padding value, (e) the second timing padding value is different from the first timing padding value in an event that the second occasion is received on the first carrier in the second time slot, and (f) a predetermined time slot is equally indicated by the first time slot plus the first timing padding value as well as by the second time slot plus the second timing padding value. The processor may be also capable of effecting one or more configurations in the predetermined time slots responsive to receiving the DL signaling in the first occasion and the second occasion.

It is noteworthy that, although description provided herein may be in the context of certain radio access technologies, networks and network topologies such as 5G NR mobile communications, the proposed concepts, schemes and any variation(s)/derivative(s) thereof may be implemented in, for and by other types of radio access technologies, networks and network topologies wherever applicable such as, for example and without limitation, Long-Term Evolution (LTE), LTE-Advanced, LTE-Advanced Pro, Internet-of-Things (IoT) and Narrow Band Internet of Things (NB-IoT). Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram of an example scenario of MAC CE with timing padding values in accordance with an implementation of the present disclosure.

FIG. 2 is a diagram of an example scenario of PDSCH in different time slots in accordance with an implementation of the present disclosure.

FIG. 3 is a diagram of an example wireless communication system in accordance with an implementation of the present disclosure.

FIG. 4 is a flowchart of an example process in accordance with an implementation of the present disclosure.

FIG. 5 is a flowchart of an example process in accordance with an implementation of the present disclosure.

FIG. 6 is a diagram of conventional MAC CE-based signaling.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

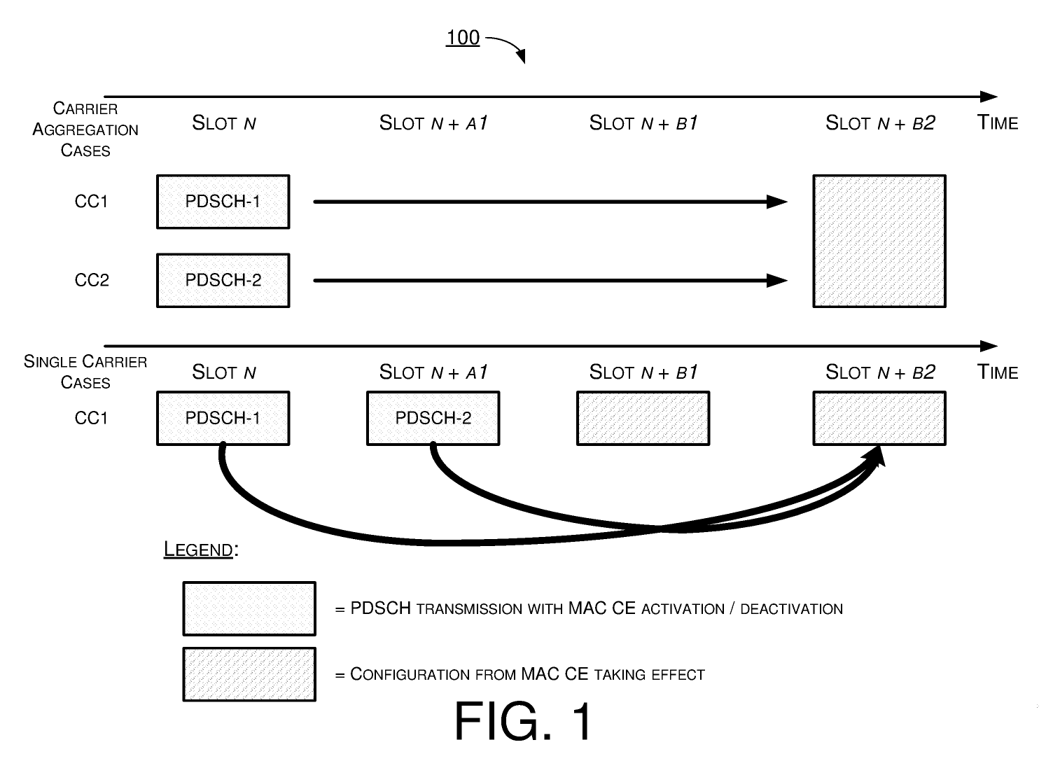

FIG. 1 illustrates an example scenario 100 of MAC CE with timing padding values in accordance with an implementation of the present disclosure. To enhance the reliability of MAC CE-based signaling, multiple copies of the MAC CE may be transmitted by a network to a UE. Referring to FIG. 1, in cases of carrier aggregation (CA), PDSCHs over two carrier components (CCs) convey the same MAC CE signaling can be transmitted to a UE. That is, a first PDSCH (labeled as “PDSCH-1” in FIG. 1) is transmitted over a first component carrier (labeled as “CC1” in FIG. 1) and a second PDSCH (labeled as “PDSCH-2” in FIG. 1) is transmitted over a second component carrier (labeled as “CC2” in FIG. 1). With the repetition/redundant transmissions, as long as one of the two CCs is received by the UE which subsequently transmits an acknowledgement that is successfully received by a network, MAC CE-based signaling (e.g., for activation) can take effect at the desired timing with a high probability.

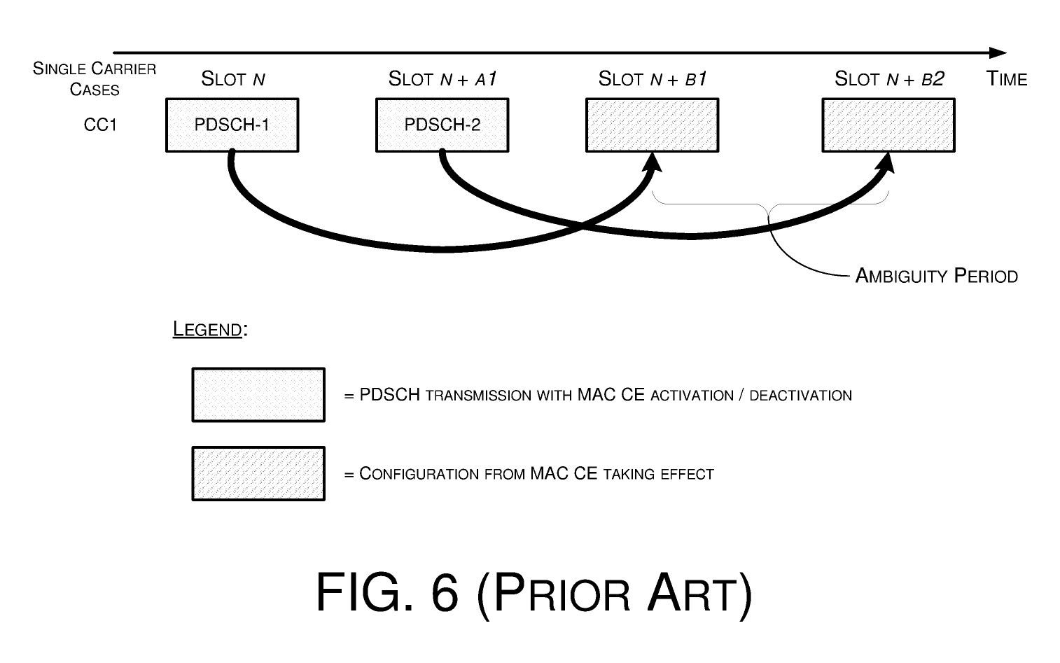

However, when only a single carrier is available at the UE, or in the case of time-division duplexing (TDD)-frequency-division duplexing (FDD) CA or TDD-CA with different downlink (DL)/uplink (UL) partitions, such a repetition or redundant transmission may not be possible. Referring to FIG. 6, in cases of a signal carrier, there can be a problem. Assuming that a MAC CE is used to reconfigure the CSI reporting trigger state in a downlink control information (DCI), the same MAC CE can be transmitted in two PDSCHs. However, there may be ambiguity on the on the “uncertainty period.” That is, depending on whether the UE receives the MAC CE activation in slot n or slot n+a1, the definition of the corresponding CSI reporting trigger state can be totally different between slot n+b1 and slot n+b2. In such case, even with repetition to address the reliability issue, an undesirable side effect of an ambiguity period (or uncertainty period) is inevitably introduced.

Current 3^{rd}-Generation Partnership Project (3GPP) specification for NR design assumes a rigid timing sequence, generally in the following chronological order: (1) a UE receives PDCCH which schedules a PDSCH from a network; (2) the UE receives the PDSCH with a MAC CE from the network; (3) the UE transmits UL ACK to the network to acknowledge receipt of the PDSCH; and (4) the signaling from the MAC CE take effect at the UE. It can be seen that, with such a rigid timing relationship, an ambiguity or uncertainty period can possibly result. Thus, various schemes are proposed in the present disclosure to avoid or otherwise eliminate the ambiguity or uncertainty period described above.

Under a proposed scheme in accordance with the present disclosure, a fast and reliable MAC CE-based signaling without an ambiguity period may be achieved. Specifically, a timing padding value c may be introduced in the MAC CE so that the MAC CE received in time slot n takes effect in slot n+c. Referring to FIG. 1, a first MAC CE signaled in time slot n may contain a timing padding value c1, and a second MAC CE signaled in time slot n+a1 may contain a timing padding value c2. The network may choose the values of c1 and c2 such that n+c1=n+a1+c2 to achieve aligned timing for both MAC CEs. Advantageously, no matter whether the UE receives PDSCH in time slot n, time slot n+a1, or both, it is indicated with the same information and the same effective timing. In cases of multiple component carriers (CCs), the same design may be also applicable to MAC CEs from different CCs.

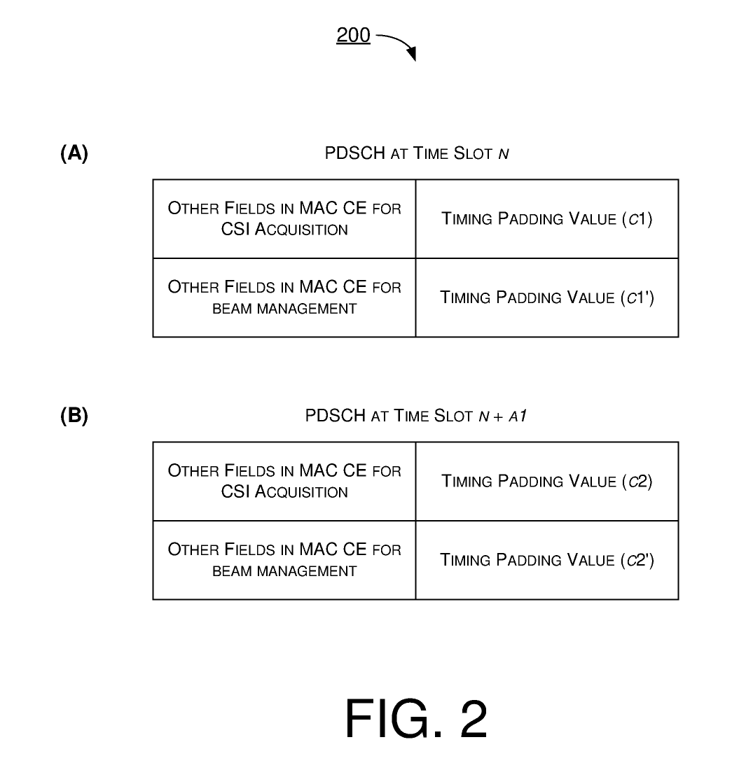

In general, under the proposed scheme, different MAC CEs in the same PDSCH may have different timing padding values. FIG. 2 illustrates an example scenario 200 of PDSCH in different time slots in accordance with an implementation of the present disclosure. Part (A) of FIG. 2 shows an example for PDSCH in time slot n. The PDSCH at time slot n may include a MAC CE for channel state information (CSI) acquisition and another MAC CE for beam management. The MAC CE may contain a timing padding value c1, and the MAC CE may contain a timing padding value c1′ different from c1. Part (B) of FIG. 2 shows an example for PDSCH in time slot n+a1. The PDSCH at time slot n+a1 may include a MAC CE for CSI acquisition and another MAC CE for beam management. The MAC CE may contain a timing padding value c2, and the MAC CE may contain a timing padding value c2′ different from c2.

Under another proposed scheme in accordance with the present disclosure, a fast and reliable dynamic signaling for PDCCH without an ambiguity period may be achieved. Under the proposed scheme, the concept of using timing padding values as described above may be applicable to dynamic signaling through PDCCH. For example, a network may transmit two PDCCHs for bandwidth part (BWP) switching, with each DCI containing a field for effective timing (potentially of different values) but pointing to the same effective time. Accordingly, a fast and reliable link without an ambiguity period may be derived from multiple uses of fast and un-reliable links.

Under yet another proposed scheme in accordance with the present disclosure, a fast and reliable dynamic signaling for physical uplink control channel (PUCCH) and physical uplink shared channel (PUSCH) without an ambiguity period may be achieved. When critical information is transmitted from a UE to a network, it may be also critical to reduce the signaling ambiguity period. In such cases, multiple transmissions of PUCCHs and/or PUSCHs with timing padding values may be used as described above.

### Illustrative Implementations

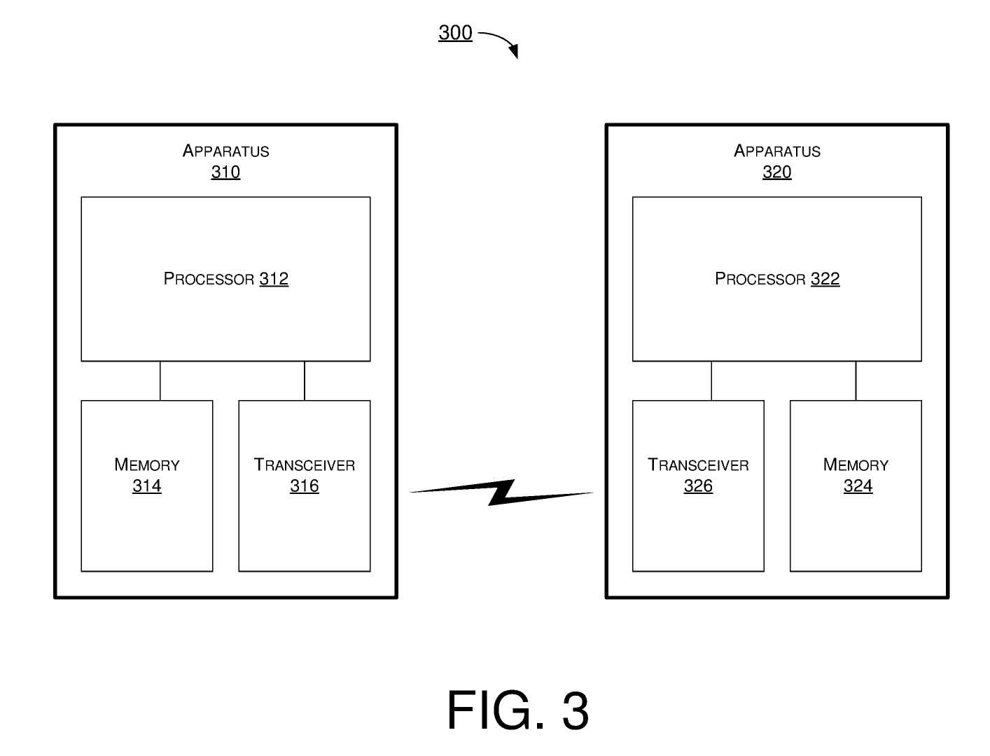

FIG. 3 illustrates an example wireless communication system 300 in accordance with an implementation of the present disclosure. Wireless communication system 300 may involve an apparatus 310 and an apparatus 320 wirelessly connected to each other. Each of apparatus 310 and apparatus 320 may perform various functions to implement procedures, schemes, techniques, processes and methods described herein pertaining to fast and reliable signaling design for mobile communications, including the various procedures, scenarios, schemes, solutions, concepts and techniques described above, including scenarios 100 and 200, as well as process 400 described below.

Each of apparatus 310 and apparatus 320 may be a part of an electronic apparatus, which may be a UE such as a portable or mobile apparatus, a wearable apparatus, a wireless communication apparatus or a computing apparatus. For instance, each of apparatus 310 and apparatus 320 may be implemented in a smartphone, a smartwatch, a personal digital assistant, a digital camera, or a computing equipment such as a tablet computer, a laptop computer or a notebook computer. Moreover, each of apparatus 310 and apparatus 320 may also be a part of a machine type apparatus, which may be an IoT or NB-IoT apparatus such as an immobile or a stationary apparatus, a home apparatus, a wire communication apparatus or a computing apparatus. For instance, each of apparatus 310 and apparatus 320 may be implemented in a smart thermostat, a smart fridge, a smart door lock, a wireless speaker or a home control center. Alternatively, each of apparatus 310 and apparatus 320 may be implemented in the form of one or more integrated-circuit (IC) chips such as, for example and without limitation, one or more single-core processors, one or more multi-core processors, one or more reduced-instruction-set-computing (RISC) processors or one or more complex-instruction-set-computing (CISC) processors.

Each of apparatus 310 and apparatus 320 may include at least some of those components shown in FIG. 3 such as a processor 312 and a processor 322, respectively. Each of apparatus 310 and apparatus 320 may further include one or more other components not pertinent to the proposed scheme of the present disclosure (e.g., internal power supply, display device and/or user interface device), and, thus, such component(s) of each of apparatus 310 and apparatus 320 are neither shown in FIG. 3 nor described below in the interest of simplicity and brevity.

In one aspect, each of processor 312 and processor 322 may be implemented in the form of one or more single-core processors, one or more multi-core processors, one or more RISC processors, or one or more CISC processors. That is, even though a singular term “a processor” is used herein to refer to processor 312 and processor 322, each of processor 312 and processor 322 may include multiple processors in some implementations and a single processor in other implementations in accordance with the present disclosure. In another aspect, each of processor 312 and processor 322 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 312 and processor 322 is a special-purpose machine specifically designed, arranged and configured to perform specific tasks pertaining to fast and reliable signaling design for mobile communications in accordance with various implementations of the present disclosure. In some implementations, each of processor 312 and processor 322 may include an electronic circuit with hardware components implementing one or more of the various proposed schemes in accordance with the present disclosure. Alternatively, other than hardware components, each of processor 312 and processor 322 may also utilize software codes and/or instructions in addition to hardware components to implement fast and reliable signaling design for mobile communications in accordance with various implementations of the present disclosure.

In some implementations, apparatus 310 may also include a transceiver 316 coupled to processor 312 and capable of wirelessly transmitting and receiving data, signals and information. In some implementations, transceiver 316 may be equipped with a plurality of antenna ports (not shown) such as, for example, four antenna ports. That is, transceiver 316 may be equipped with multiple transmit antennas and multiple receive antennas for MIMO wireless communications. In some implementations, apparatus 310 may further include a memory 314 coupled to processor 312 and capable of being accessed by processor 312 and storing data therein. In some implementations, apparatus 320 may also include a transceiver 326 coupled to processor 322 and capable of wirelessly transmitting and receiving data, signals and information. In some implementations, transceiver 326 may be equipped with a plurality of antenna ports (not shown) such as, for example, four antenna ports. That is, transceiver 326 may be equipped with multiple transmit antennas and multiple receive antennas for MIMO wireless communications. In some implementations, apparatus 320 may further include a memory 324 coupled to processor 322 and capable of being accessed by processor 322 and storing data therein. Accordingly, apparatus 310 and apparatus 320 may wirelessly communicate with each other via transceiver 316 and transceiver 326, respectively.

To aid better understanding, the following description of the operations, functionalities and capabilities of each of apparatus 310 and apparatus 320 is provided in the context of a mobile communication environment in which apparatus 310 is implemented in or as a first network node (e.g., UE 110 in scenario 100) of a wireless network (e.g., network 120 as a 5G NR mobile network).and apparatus 320 is implemented in or as a second network node (e.g., network node 125 as a gNB or TRP) of the wireless network.

Under various proposed schemes in accordance with the present disclosure, processor 312 of apparatus 310 as a first network node of a wireless network may receive, via transceiver 316, DL signaling from apparatus 320 as a second network node of the wireless network in a first occasion and a second occasion, such that: (a) the first occasion is received on a first carrier in a first time slot, (b) the second occasion is received either on the first carrier in a second time slot after the first time slot or on a second carrier in the first time slot or the second time slot, (c) a MAC CE in the DL signaling received in the first occasion comprises a first timing padding value, (d) the MAC CE in the DL signaling received in the second occasion comprises a second timing padding value, (e) the second timing padding value is different from the first timing padding value in an event that the second occasion is received on the first carrier in the second time slot, and (f) a first predetermined time slot is equally indicated by the first time slot plus the first timing padding value as well as by the second time slot plus the second timing padding value. Moreover, processor 312 may effect one or more configurations in the first predetermined time slots responsive to receiving the DL signaling in the first occasion and the second occasion.

In some implementations, the DL signaling may include a plurality of MAC CEs. In such cases, respective timing padding values in the plurality of MAC CEs may be different. For instance, a first MAC CE may contain one timing padding value while a second MAC CE may contain another timing padding value that is different.

In some implementations, in receiving the DL signaling, processor 312 may receive a physical downlink shared channel (PDSCH). In some implementations, in effecting the one or more configurations, processor 312 may perform a MAC CE-based activation. Alternatively, in effecting the one or more configurations, processor 312 may perform a MAC CE-based deactivation.

In some implementations, in receiving the DL signaling, processor 312 may receive a physical downlink control channel (PDCCH). In some implementations, in effecting the one or more configurations, processor 312 may perform bandwidth part (BWP) switching.

In some implementations, processor 312 may perform additional operations. For instance, processor 312 may transmit, via transceiver 316, UL signaling to apparatus 320 in a third occasion and a fourth occasion, such that: (a) the third occasion is transmitted on a third carrier in a third time slot, (b) the fourth occasion is transmitted either on the third carrier in a fourth time slot after the third time slot or on a fourth carrier in the third time slot or the fourth time slot, (c) a second MAC CE in the UL signaling transmitted in the third occasion comprises a third timing padding value, (d) the second MAC CE in the UL signaling transmitted in the fourth occasion comprises a fourth timing padding value, (e) the fourth timing padding value is different from the third timing padding value in an event that the fourth occasion is transmitted on the third carrier in the fourth time slot, and (f) a second predetermined time slot is equally indicated by the third time slot plus the third timing padding value as well as by the fourth time slot plus the fourth timing padding value.

In some implementations, in transmitting the UL signaling, processor 312 may transmit a physical uplink control channel (PUCCH).

In some implementations, in transmitting the UL signaling, processor 312 may transmit a physical uplink shared channel (PUSCH).

### Illustrative Processes

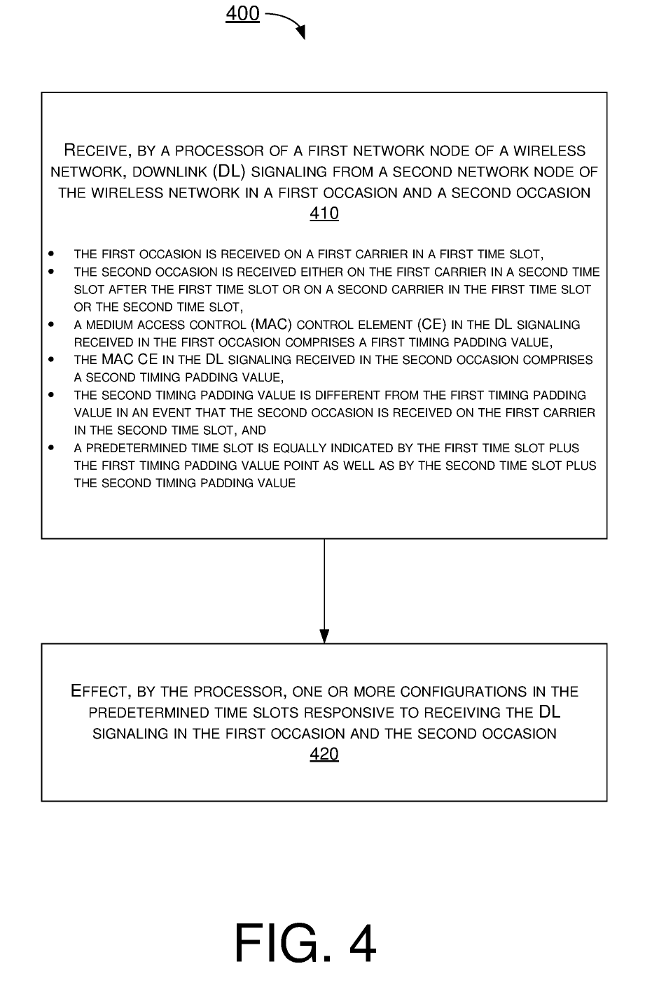

FIG. 4 illustrates an example process 400 in accordance with an implementation of the present disclosure. Process 400 may be an example implementation of the various procedures, scenarios, schemes, solutions, concepts and techniques, or a combination thereof, whether partially or completely, with respect to fast and reliable signaling design for mobile communications in accordance with the present disclosure. Process 400 may represent an aspect of implementation of features of apparatus 310 and/or apparatus 320. Process 400 may include one or more operations, actions, or functions as illustrated by one or more of blocks 410 and 420. Although illustrated as discrete blocks, various blocks of process 400 may be divided into additional blocks, combined into fewer blocks, or eliminated, depending on the desired implementation. Moreover, the blocks of process 400 may be executed in the order shown in FIG. 4 or, alternatively, in a different order. Furthermore, one or more of the blocks of process 400 may be repeated one or more times. Process 400 may be implemented by apparatus 310 or any suitable UE or machine type devices. Solely for illustrative purposes and without limitation, process 400 is described below in the context of apparatus 310 as a first network node (e.g., UE) of a wireless network (e.g., 5G NR mobile network) and apparatus 320 as a second network node (e.g., gNB or TRP) of the wireless network. Process 400 may begin at block 410.

At 410, process 400 may involve processor 312 of apparatus 310 as a first network node receiving, via transceiver 316, DL signaling from apparatus 320 as a second network node of a wireless network in a first occasion and a second occasion, such that: (a) the first occasion is received on a first carrier in a first time slot, (b) the second occasion is received either on the first carrier in a second time slot after the first time slot or on a second carrier in the first time slot or the second time slot, (c) a MAC CE in the DL signaling received in the first occasion comprises a first timing padding value, (d) the MAC CE in the DL signaling received in the second occasion comprises a second timing padding value, (e) the second timing padding value is different from the first timing padding value in an event that the second occasion is received on the first carrier in the second time slot, and (f) a first predetermined time slot is equally indicated by the first time slot plus the first timing padding value as well as by the second time slot plus the second timing padding value. Process 400 may proceed from 410 to 420.

At 420, process 400 may involve processor 312 effecting one or more configurations in the first predetermined time slots responsive to receiving the DL signaling in the first occasion and the second occasion.

In some implementations, the DL signaling may include a plurality of MAC CEs. In such cases, respective timing padding values in the plurality of MAC CEs may be different. For instance, a first MAC CE may contain one timing padding value while a second MAC CE may contain another timing padding value that is different.

In some implementations, in receiving the DL signaling, processor 400 may involve processor 312 receiving a physical downlink shared channel (PDSCH). In some implementations, in effecting the one or more configurations, processor 400 may involve processor 312 performing a MAC CE-based activation. Alternatively, in effecting the one or more configurations, processor 400 may involve processor 312 performing a MAC CE-based deactivation.

In some implementations, in receiving the DL signaling, processor 400 may involve processor 312 receiving a physical downlink control channel (PDCCH). In some implementations, in effecting the one or more configurations, processor 400 may involve processor 312 performing bandwidth part (BWP) switching.

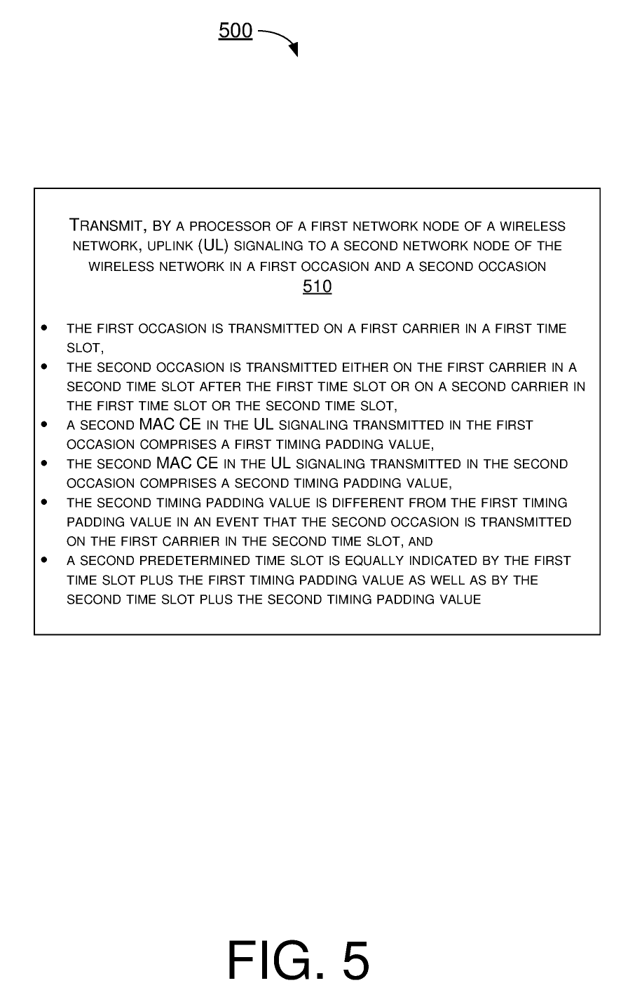

FIG. 5 illustrates an example process 500 in accordance with an implementation of the present disclosure. Process 500 may be an example implementation of the various procedures, scenarios, schemes, solutions, concepts and techniques, or a combination thereof, whether partially or completely, with respect to fast and reliable signaling design for mobile communications in accordance with the present disclosure. Process 500 may represent an aspect of implementation of features of apparatus 310 and/or apparatus 320. Process 500 may include one or more operations, actions, or functions as illustrated by block 510. Although illustrated as discrete blocks, various blocks of process 500 may be divided into additional blocks, combined into fewer blocks, or eliminated, depending on the desired implementation. Moreover, the blocks of process 500 may be executed in the order shown in FIG. 5 or, alternatively, in a different order. Furthermore, one or more of the blocks of process 500 may be repeated one or more times. Process 500 may be implemented by apparatus 310 or any suitable UE or machine type devices. Solely for illustrative purposes and without limitation, process 500 is described below in the context of apparatus 310 as a first network node (e.g., UE) of a wireless network (e.g., 5G NR mobile network) and apparatus 320 as a second network node (e.g., gNB or TRP) of the wireless network. Process 500 may begin at block 510.

At 510, process 500 may involve processor 312 of apparatus 310 as a first network node transmitting, via transceiver 316, UL signaling to apparatus 320 as a second network node in a first occasion and a second occasion, such that: (a) the first occasion is transmitted on a first carrier in a first time slot, (b) the second occasion is transmitted either on the first carrier in a second time slot after the first time slot or on a second carrier in the first time slot or the second time slot, (c) a second MAC CE in the UL signaling transmitted in the first occasion comprises a first timing padding value, (d) the second MAC CE in the UL signaling transmitted in the second occasion comprises a second timing padding value, (e) the second timing padding value is different from the first timing padding value in an event that the second occasion is transmitted on the first carrier in the second time slot, and (f) a second predetermined time slot is equally indicated by the first time slot plus the first timing padding value as well as by the second time slot plus the second timing padding value.

In some implementations, in transmitting the UL signaling, process 500 may involve processor 312 transmitting a physical uplink control channel (PUCCH).

In some implementations, in transmitting the UL signaling, process 500 may involve processor 312 transmitting a physical uplink shared channel (PUSCH).

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
receiving, by a processor of a first network node of a wireless network, downlink (DL) signaling from a second network node of the wireless network in a first occasion and a second occasion, such that:
the first occasion is received on a first carrier in a first time slot,
the second occasion is received either on the first carrier in a second time slot after the first time slot or on a second carrier in the first time slot or the second time slot,
a medium access control (MAC) control element (CE) in the DL signaling received in the first occasion comprises a first timing padding value,
the MAC CE in the DL signaling received in the second occasion comprises a second timing padding value,
the second timing padding value is different from the first timing padding value in an event that the second occasion is received on the first carrier in the second time slot, and
a predetermined time slot is equally indicated by the first time slot plus the first timing padding value as well as by the second time slot plus the second timing padding value; and
effecting, by the processor, one or more configurations in the predetermined time slots responsive to receiving the DL signaling in the first occasion and the second occasion.

2. The method of claim 1, wherein the DL signaling comprises a plurality of MAC CEs, and wherein respective timing padding values in the plurality of MAC CEs are different.

3. The method of claim 1, wherein the receiving of the DL signaling comprises receiving a physical downlink shared channel (PDSCH).

4. The method of claim 3, wherein the effecting of the one or more configurations comprises performing a MAC CE-based activation.

5. The method of claim 3, wherein the effecting of the one or more configurations comprises performing a MAC CE-based deactivation.

6. The method of claim 1, wherein the receiving of the DL signaling comprises receiving a physical downlink control channel (PDCCH).

7. The method of claim 6, wherein the effecting of the one or more configurations comprises performing bandwidth part (BWP) switching.

8. A method, comprising:
transmitting, by a processor of a first network node of a wireless network, uplink (UL) signaling to a second network node of the wireless network in a first occasion and a second occasion, such that:
the first occasion is transmitted on a first carrier in a first time slot,
the second occasion is transmitted either on the first carrier in a second time slot after the first time slot or on a second carrier in the first time slot or the second time slot,
a second MAC CE in the UL signaling transmitted in the first occasion comprises a first timing padding value,
the second MAC CE in the UL signaling transmitted in the second occasion comprises a second timing padding value,
the second timing padding value is different from the first timing padding value in an event that the second occasion is transmitted on the first carrier in the second time slot, and
a second predetermined time slot is equally indicated by the first time slot plus the first timing padding value as well as by the second time slot plus the second timing padding value.

9. The method of claim 8, wherein the transmitting of the UL signaling comprises transmitting a physical uplink control channel (PUCCH).

10. The method of claim 8, wherein the transmitting of the UL signaling comprises transmitting a physical uplink shared channel (PUSCH).

11. An apparatus implemented in a first network node of a wireless network, comprising:
a transceiver which, during operation, wirelessly communicates with a second network node of the wireless network; and
a processor coupled to the transceiver such that, during operation, the processor performs operations comprising:
receiving, via the transceiver, downlink (DL) signaling from the second network node in a first occasion and a second occasion, such that:
the first occasion is received on a first carrier in a first time slot,
the second occasion is received either on the first carrier in a second time slot after the first time slot or on a second carrier in the first time slot or the second time slot,
a medium access control (MAC) control element (CE) in the DL signaling received in the first occasion comprises a first timing padding value,
the MAC CE in the DL signaling received in the second occasion comprises a second timing padding value,
the second timing padding value is different from the first timing padding value in an event that the second occasion is received on the first carrier in the second time slot, and
a predetermined time slot is equally indicated by the first time slot plus the first timing padding value as well as by the second time slot plus the second timing padding value; and
effecting one or more configurations in the predetermined time slots responsive to receiving the DL signaling in the first occasion and the second occasion.

12. The apparatus of claim 11, wherein the DL signaling comprises a plurality of MAC CEs, and wherein respective timing padding values in the plurality of MAC CEs are different.

13. The apparatus of claim 11, wherein, in receiving the DL signaling, the processor receives a physical downlink shared channel (PDSCH).

14. The apparatus of claim 13, wherein, in effecting the one or more configurations, the processor performs a MAC CE-based activation.

15. The apparatus of claim 13, wherein, in effecting the one or more configurations, the processor performs a MAC CE-based deactivation.

16. The apparatus of claim 11, wherein, in receiving the DL signaling, the processor receives a physical downlink control channel (PDCCH).

17. The apparatus of claim 16, wherein, in effecting the one or more configurations, the processor performs bandwidth part (BWP) switching.

18. The apparatus of claim 11, the processor further performs operations comprising:
transmitting, via the transceiver, uplink (UL) signaling to the second network node in a third occasion and a fourth occasion, such that:
the third occasion is transmitted on a third carrier in a third time slot,
the fourth occasion is transmitted either on the third carrier in a fourth time slot after the third time slot or on a fourth carrier in the third time slot or the fourth time slot,
a second MAC CE in the UL signaling transmitted in the third occasion comprises a third timing padding value,
the second MAC CE in the UL signaling received in the fourth occasion comprises a fourth timing padding value,
the fourth timing padding value is different from the third timing padding value in an event that the fourth occasion is transmitted on the third carrier in the fourth time slot, and
a second predetermined time slot is equally indicated by the third time slot plus the third timing padding value as well as by the fourth time slot plus the fourth timing padding value.

19. The apparatus of claim 18, wherein, in transmitting the UL signaling, the processor transmits a physical uplink control channel (PUCCH).

20. The apparatus of claim 18, wherein, in transmitting the UL signaling, the processor transmits a physical uplink shared channel (PUSCH).
